(19) United States
(12) Patent Application Publication
(10) Pub. No.: US 2011/0221845 A1
(43) Pub. Date: Sep. 15, 2011

(54) RECORDING UNIT

(75) Inventor: Hiroshi UE, Matsumoto-shi (JP)

(73) Assignee: SEIKO EPSON CORPORATION, Tokyo (JP)

(21) Appl. No.: 13/045,807

(22) Filed: Mar. 11, 2011

(30) Foreign Application Priority Data
Mar. 12, 2010 (JP) 2010-055432

(51) Int. Cl. B41J 2/01

(52) U.S. Cl. 347/104

(57) ABSTRACT

Suction holes are formed in a stacking plane of an output tray, a recording medium recorded by a recording section being placed on the stacking plane. Air above the output tray is drawn through the suction holes, and the drawn air is supplied to the recorded side of the recording medium through an air feed guide disposed downstream of the recording section in the feed direction.

### CROSS-REFERENCE TO RELATED APPLICATIONS

This application claims the benefit of priority to Japanese Patent Application No. 2010-055432 filed Mar. 12, 2010, the contents of which are hereby incorporated by reference in their entirety.

### BACKGROUND

1. Technical Field

The present invention relates to a recording unit that includes a feeder that feeds out a recording medium in a feed direction, a feed path through which the recording medium fed out by the feeder is guided in a feed direction, a recording section that carries out recording on the recording medium fed through the feed path, and an output tray, disposed downstream of the recording section, on which the recording medium recorded by the recording section is stacked.

The recording unit in this application is one of ink jet printers, wire dot printers, laser printers, line printers, copiers, facsimile machines, and the like.

2. Related Art

A small-sized copier in related art, which is a later printer, has a paper ejection unit from which recorded sheets are ejected. The paper ejection unit has paper ejection rollers, a paper ejection tray, a vent, and a fan, as described in JP-A-2002-167106. The paper ejection rollers are disposed so that recorded sheets are ejected onto the paper ejection tray. The vent is formed on a wall surface of the case of the small-sized copier, the wall being disposed upstream of the direction in which the recorded sheet is fed out of (ejected from) the paper ejection tray.

The fan draws air through the vent to generate an airflow. Specifically, the airflow is used to make a sheet, which has been ejected by the ejection rollers, approach the wall side by suction by suction. The sheet drops onto the paper ejection tray while the sheet is inclined with its edge near the wall surface slightly lowered. The rear edge of the sheet, which is the upstream end of the sheet, is brought into contact with the wall surface.

Accordingly, sheets ejected onto the paper ejection tray can be neatly aligned.

However, a sheet ejected onto the paper ejection tray may be curled by, for example, swelling due to absorbed ink, and the curled portion may block part of the ejection slot.

FIGS. 10A and 10B show warps (curs) of sheets ejected onto the paper ejection tray, which are a problem in this application. FIG. 10A is a schematic vertical cross sectional view, and FIG. 10B is a schematic cross sectional view taken along line XB-XB in FIG. 10A, as viewed toward the front.

As shown in FIGS. 10A and 10B, a printer 60 includes a paper ejection tray 61, an ejection slot 63, and an ejection roller pair 64. The paper ejection tray 61 has a stacking plane 62 on which sheets 65 are stacked. The ejection slot 63 is formed vertically above the stacking plane 62. The ejection roller pair 64 is structured so that the recorded sheets 65 can be ejected onto the paper ejection tray 61 through the ejection slot 63.

The X-axis indicates the width direction of the sheet 65, the arrow of the Y-axis indicates a direction toward the downstream in the direction in which the sheet 65 is fed, and the arrow of the Z-axis indicates a direction toward an upper part of the vertical direction.

If a leading sheet 67 (65) ejected onto the paper ejection tray 61 is curled, a curled portion 66 of the leading sheet 67 may block part of the ejection slot 63, as described above. In this case, when the following sheet 68 (65) is ejected, the front edge of the following sheet 68 may strike the rear edge of the curled portion 66 of the leading sheet 67, which has been ejected, by which the leading sheet 67 may be pushed forward. If the following sheet 68 cannot push the leading sheet 67 forward due to its frictional resistance or its own weight, the following sheet 68 may fail to be completely ejected from the ejection slot 63 and the ejection slot 63 may be clogged, that is, a so-called paper jam may be caused. Furthermore, the front edge of the following sheet 68 may slide below the leading sheet 67, and the page sequence may be altered.

### SUMMARY

An advantage of some aspects of the invention is to provide a recording unit structured in consideration of curls formed on a recording sheet ejected on an output tray.

A recording unit according to a first aspect of the invention is a recording unit that carries out recording on a recording medium; the recording unit includes a feeder that feeds out a recording medium in a feed direction, a feed path through which the recording medium fed out by the feeder is guided in the feed direction, a recording section that carries out recording on the recording medium fed through the feed path, an output tray, disposed downstream of the recording section in the feed direction, on which the recording medium recorded by the recording section is stacked, suction holes formed in a stacking plane, on which the recording medium is stacked, of the output tray, and an air feed guide through which air drawn from the suction holes is supplied to the recorded side of the recording medium in a place, on the feed path, downstream of the recording section in the feed direction.

According to the first aspect of the invention, even if the recording medium on the output tray is curled, a space formed by the curl can be reduced and even can be eliminated by drawing air in the space. That is, curls of the recording medium on the output tray can be suppressed.

It is also possible to reduce a change in the state of the recording medium recorded by the recording section (the temperature of the sheet and the degree of printing on it) by directing the drawn air to the recorded side.

If, for example, the recording medium is a sheet and the recording section is structured so that ink is expelled, that is, the recording section is a so-called ink jet printer, then because the sheet absorbs ink and swells, the recorded side tends to outwardly curl. When the drawn air is directed to the recorded side, drying is hastened, suppressing the degree of curling.

If the recording section is structured so that toner adheres to the sheet and heat and pressure are applied for recording on the sheet, that is, the recording unit is a so-called laser printer, then the sheet tends to contract on its recording side, to which heat has been applied, and to curl with the recorded side being the inner surface. When the drawn air is directed to the recorded side, cooling is hastened, suppressing the degree of curling.

Then, it is possible to prevent the problem that the leading recording medium is pushed forward on the output tray, the problem of a jam caused by the following recording medium, and the problem that the following recording medium slides below the already stacked leading recording medium and the page sequence is altered.

In the first aspect, the stacking plane of the output tray in a second aspect of the invention is enclosed by side walls disposed apart from edges of stacked recording media; the suction holes in the second aspect are formed among the side walls and the edges of the recording media.

According to the second aspect, a suction force by a suction unit can also be reliably exerted on the recording medium at the top in the stacking direction, besides the effect obtained in the first aspect. Specifically, even if a recording medium sequentially stacked on the lowest recording medium in the stacking direction is curled, air can be drawn between the curled recoding media and the non-curled recording media below the curled recording medium. The degree of the curling of the curled recording medium can be suppressed by reducing or eliminating the space between the curled recording medium and the non-curled recording medium below the curled recording medium. Particularly, the second aspect is effective when edges of the recording medium upwardly curl.

In the first aspect, the output tray in a third aspect of the invention further includes side walls, which are disposed apart from edges of stacked recording media so as to enclose the stacking plane, and a plurality of ribs within a range in which recoding media are stacked on the stacking plan; the suction holes in the third aspect are formed within the range in which recording media are stacked.

According to the third aspect, the suction force by the suction unit can also be reliably exerted on the recording medium at the top in the stacking direction as in the second aspect, besides the effect obtained in the first aspect. The lowest recording medium in the stacking direction is supported by the plurality of ribs. Since the suction holes face the lowest recording medium, the suction force by the suction unit can be exerted on the lowest recording medium.

A clearance can be provided by the plurality of ribs between the lowest recording medium and stacking plane. Air among the recording media at the top and the side walls can be drawn through the clearance. Even if a recording medium sequentially stacked on the lowest recording medium is curled, air between the curled recording medium and a non-curled recording medium below the curled recording medium can be drawn. The degree of the curling of the curled recording medium can be suppressed by reducing or eliminating the space between the curled recording medium and the non-curled recording medium below the curled recording medium.

In the first aspect, the output tray in a fourth aspect of the invention further includes an ejection slot, through which recording media are ejected from the feed path onto the output tray, and films made of an elastic material, the films being disposed below the ejection slot in the vertical direction; the stacking plane of the output tray is enclosed by side walls disposed apart from edges of stacked recording media. The film is disposed so as to face the inside of a range enclosed by the side walls. Part of the surface of the film can be brought into contact with an end of a curled recording medium on the output tray.

According to the fourth aspect, the flow path, through which air flows due to the suction force, can be narrowed in the vicinity of the edges of the curled recording medium. Accordingly, the suction force can be efficiently applied.

An enclosed space with no clearance can be defined by the edges of the curled recording medium, the films, the side walls, and the stacking plane.

As a result, the suction force by the suction unit can be efficiently exerted. The degree of curling can be reduced by downwardly drawing the edges of the curled recording medium. Since the film is made of an elastic material, it can be deformed so as to evacuate the outside of the range enclosed by the side walls or downwardly in the vertical direction. That is, the film does not prevent the curled recording medium from entering a non-curled state. The edges of the curled recording medium can be similarly drawn downwardly.

Since the film is elastic as describe above, it can reliably come into contact with an edge of the curled recording medium, regardless of the size of the curl. Accordingly, a curl can be suppressed, regardless of its size.

Since the film is disposed below the ejection slot in the vertical direction, there is no risk that ejection of the following recording medium is prevented.

If the recording medium is a sheet, its fibrous direction is usually along the longer edges, that is, the sheet is in the long grain direction. When the sheet is stacked so that the longer edges are oriented in the feed direction, the fibrous direction matches the feed direction. The sheet is likely to be bent in a direction parallel to the fiber, that is, tends to curl in such a way that the side edges in the width direction with respect to the feed direction are deformed upwardly or downwardly. Therefore, the films preferably come into contact with the side edges on both sides of the sheet to suppress curls near the side edges on both sides.

In any one of the first to fourth aspects, the output tray in a fifth aspect of the invention is structured so that the recording medium recorded by the recording section is stacked on the stacking plane with the recorded side of the recording medium facing the stacking plane.

According to the fifth aspect, besides the effect obtained in any one of the first to the fourth aspects, if a recording medium on the output tray has been curled, air on the recorded side of the recording medium can be always drawn. As a result, the drying on the recorded side can be hastened by the air flow generated by air suction.

In any one of the first to fifth aspects, the recording section in a sixth aspect of the invention expels ink to record on the recording medium and the recording medium is a sheet.

According to the sixth aspect, besides the effect obtained in any one of the first to the fifth aspects, the suction unit is particularly effective to solve the specific problem that the sheet may be curled due to swelling.

### BRIEF DESCRIPTION OF THE DRAWINGS

The invention will be described with reference to the accompanying drawings, wherein like numbers reference like elements.

FIG. 1 is a side view that schematically shows the interior of a printer according to an embodiment of the invention before a sheet is fed.

FIG. 2 is a side view that schematically shows the interior of the printer when the sheet is fed and recorded.

FIG. 3 is a side view that schematically shows the interior of the printer when the sheet is ejected.

FIG. 4 is a side view that schematically shows the interior of the printer when the sheet is reversed and fed.

FIG. 5 is a schematic cross sectional view of an ejection stacker in the embodiment of the invention, when viewed from the front.

FIG. 6 is a schematic cross sectional view of an ejection stacker in a first alternative embodiment of the invention, when viewed from the front.

FIG. 7 is a schematic cross sectional view of an ejection stacker in a second alternative embodiment of the invention, when viewed from the front.

FIGS. 8A and 8B are cross sectional views of an ejection stacker in a third alternative embodiment of the invention, when viewed from the front.

FIGS. 9A and 9B are other cross sectional views of the ejection stacker in the third alternative embodiment of the invention, when viewed from the front.

FIGS. 10A and 10B show curs of ejected sheets, which are a problem in this application.

### DESCRIPTION OF EXEMPLARY EMBODIMENTS

Embodiments of the invention will be described below with reference to the drawings.

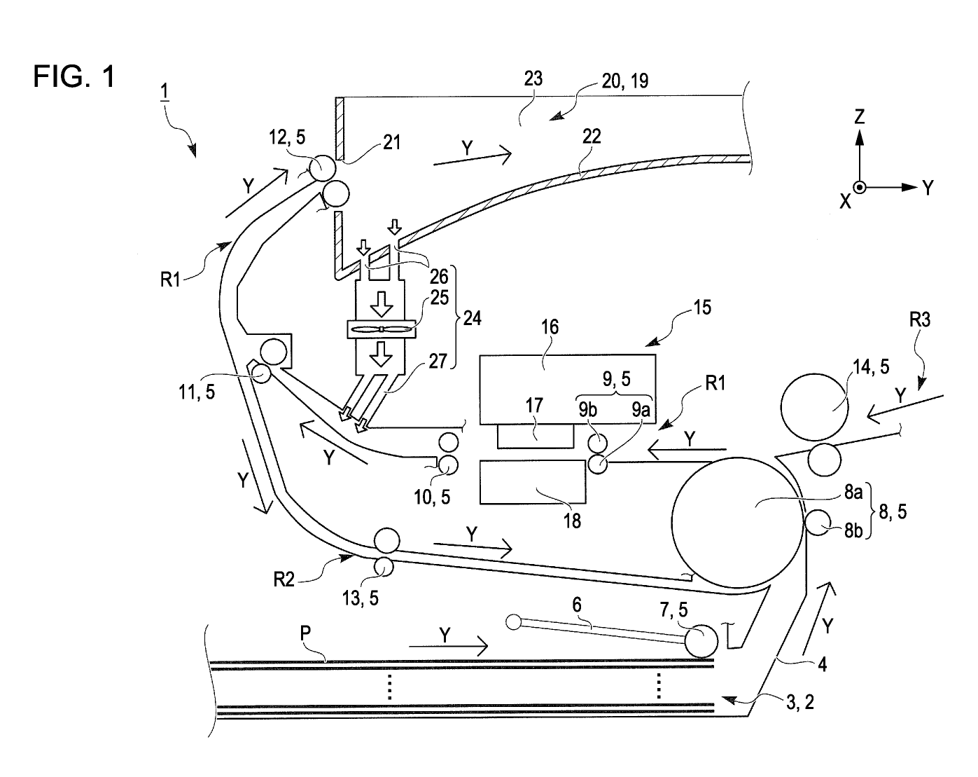

FIG. 1 is a side view that schematically shows the interior of a printer, which is an example of a recording unit according to an embodiment of the invention, before a sheet is fed.

As shown in FIG. 1, the printer 1 includes a first output tray 2, feed paths R1 to R3, a feeder 5, a recording section 15, a second output tray 19, and a suction unit 24.

The first output tray 2 is disposed so that sheets P, which are an example of recording media before they are fed, are stacked. Specifically, the printer 1 has a medium cassette 3 as the first output tray 2, which can be attached to and detached from the printer body. The medium cassette 3 has movable edge guides so that sheets P with various sizes can be stacked.

A separator 4 is provided for a pickup roller 7 described later, the separator being positioned downstream of a place where sheets P are stacked in the medium cassette 3 in the feed direction. In case of multi-feed, the separator 4 separates the uppermost sheet P from the subsequent sheets P. An example of the separator 4 is a so-called bank separator.

The bank separator has a plane so that sheets P proceed at a predetermined angle. A load is applied to an end of the sheet P to separate it.

The feed paths R1 to R3, through which sheets P are fed, are formed with medium guides that guide sheets P fed by the feeder 5. The feed paths R1, R2, R3 are respectively referred to as the first feed path R1, second feed path R2, and third feed path R3. The first feed path R1 is a path extending from the medium cassette 3 through the recording section 15 to the second output tray 19. The second feed path R2 is a path through which the sheet P is inverted and fed from the downstream of the recording section 15 in the feed direction during recording to the upstream of the recording section 15. The third feed path R3 is a path through which the sheet P is guided from a place other than the medium cassette 3 to the recording section 15.

The feeder 5 has a roller and other parts that are driven by the power of a motor (not shown) controlled by a controller (not shown), by which the sheet P is fed in the feed direction Y. Specifically, the feeder 5 has the pickup roller 7 and a first roller pair 8 to a seventh roller pair 14, for example. The pickup roller 7 is disposed at one end of an arm 6, which swings centered around the other end. The pickup roller 7 can come into contact with the uppermost sheet P of sheets P stacked on the medium cassette 3.

The first roller pair 8 is disposed downstream of the pickup roller 7 on the first feed path R1 and downstream of the sixth roller pair 13, described later, on the second feed path R2. The first roller pair 8 is structured so that the sheet P fed by the pickup roller 7 or sixth roller pair 13 can be fed further downstream in the feed direction.

Specifically, the first roller pair 8 includes a first drive roller 8a and a first driven roller 8b.

A so-called retard roller, which accompanies a predetermined load during rotation, may be used instead of the first driven roller 8b. Even if separation by the bank separator is insufficient, the retard roller can reliably separate multi-fed sheets. That is, the sheet P with which the first drive roller 8a is directly placed in contact can be separated from a sheet or sheets that are closer to the retard roller than the sheet P is.

The second roller pair 9 is disposed downstream of first roller pair 8 on the first feed path R1 and downstream of the seventh roller pair 14, described later, on the third feed path R3. The second roller pair 9 is structured so that the sheet P fed by the first roller pair 8 or seventh roller pair 14 can be fed further downstream in the feed direction.

Specifically, the second roller pair 9 includes a second drive roller 9a and a second driven roller 9b. The sheet P can be precisely fed to the recording section 15 by, for example, a stepper motor.

Of course, the second roller pair 9 is structured so that when an edge of the sheet P reaches the second roller pair 9, so-called skew removal, in which the orientation of the sheet P in the feed direction Y is corrected, is performed.

The third roller pair 10 is disposed downstream of the recording section 15 on the first path R1. The third roller pair 10 is structured so that the sheet P fed by the second roller pair 9 and recorded by the recording section 15 can be fed further downstream in the feed direction.

Similarly, the fourth roller pair 11 is disposed downstream of the third roller pair 10 on the first feed path R1. The fourth roller pair 11 is structured so that the sheet P fed by the third roller pair 10 can be fed further downstream in the feed direction.

The fifth roller pair 12 is disposed downstream of the fourth roller pair 11 on the first path R1. The fifth roller pair 12 is structured so that the sheet P fed by the fourth roller pair 11 can be fed to the second output tray 19 disposed further downstream in the feed direction through an ejection slot 21. A double-sided recording mode, in which recording is performed on the front side and back side of the sheet P, may be effected.

In the double-sided recording mode, the fifth roller pair 12 is reversely driven, that is, undergoes so-called switch back when the sheet P, for which recording has been completed on the front side but not on the back side, is pressed and placed in a state in which the sheet P is ready to enter the second feed path R2.

The sheet P becomes ready to enter the above state when its rear edge passes the fourth roller pair 11 and is pressed outward along the curved portion of the first feed path R1, which is curved when viewed from a side.

The sixth roller pair 13 is disposed downstream of the fifth roller pair 12 in the feed direction. The sixth roller pair 13 is operable when the fifth roller pair 12 is reversely driven on the second feed path R2; the sixth roller pair 13 is structured so that the sheet P can be fed to the first roller pair 8 with its front and rear edges reversed, that is, the rear edge during the printing on the front side becomes the front edge. In this case, the front side and back side of the sheet P are reversed.

The seventh roller pair 14 is disposed upstream of the second roller pair 9 on the third path R3. The seventh roller pair 14 is structured so that sheets P stacked on a tray other than the medium cassette 3, such as, for example, a manual feed tray, can be fed to the second roller pair 9.

The recording section 15 carries out recording on the sheet P. In this embodiment, the recording section 15 includes a carriage 16, a recording head 17, and a medium support 18. The carriage 16 is moved by the power of a moving mechanism (not shown) in the width direction X of the sheet P while being guided by guide shafts (not shown) extending in the width direction X. The recording head 17 is disposed in the carriage 16; it expels ink to the sheet P, that is, performs so-called ink-jet recording.

The medium support 18 is disposed so as to face the recording head 17; it supports the sheet P in such a way that the distance between the sheet P and recording head 17 can be fixed.

Although, in this embodiment, the recording section 15 of the ink-jet type, which expels ink, is used, another structure may be used. For example, the recording unit may be a laser printer in which toner adheres to the sheet P and heat and pressure are applied for recording on the sheet P.

The second output tray 19 is disposed so that recorded sheets P are stacked. The following sheet P is stacked at the top in the vertical direction. Specifically, the second output tray 19 has an ejection stacker 20 having a stacking plane 22. The ejection stacker 20 also has an ejection slot 21 above the stacking plane 22 in the vertical direction, which is disposed upstream in the feed direction in ejection. The sheet P ejected by the fifth roller pair 12 passes through the ejection slot 21. The circumference of the stacking plane 22 is enclosed by side walls 23.

The suction unit 24 draws air above the ejection stacker 20. Specifically, the suction unit 24 includes a plurality of suction holes 26, a fan 25, and an air feed guide 27. The plurality of suction holes 26 is formed at least upstream in the feed direction on the stacking plane 22 of the ejection stacker 20. The plurality of suction holes 26 may be formed across the stacking plane 22 in the feed direction. This is because the same effect can be obtained, as described below.

The fan 25 of the suction unit 24 draws air above the ejection stacker 20 through the plurality of suction holes 26. The air feed guide 27 guides the drawn air to the front side of the sheet P at the downstream of the recording section 15 so that the drawn air strikes the front side.

The X-axis indicates the width direction of the sheet P, the arrow of the Y-axis indicates a direction toward the downstream in the direction in which the sheet P is fed, and the arrow of the Z-axis indicates a direction toward an upper part of the vertical direction.

Next, an operation of the feed of the sheet P will be described.

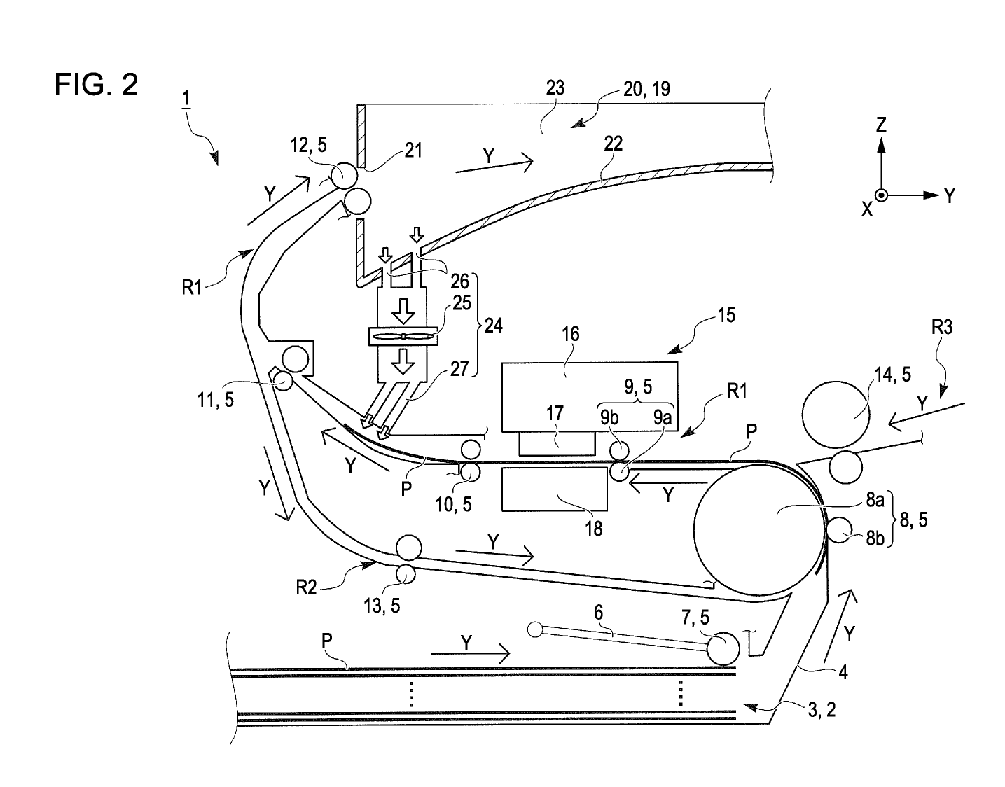

FIG. 2 is a side view that schematically shows the interior of the printer, which is an example of the recording unit according to the embodiment of the invention, when the sheet P is fed and recorded.

When the pickup roller 7 is swung counterclockwise from the state shown in FIG. 1, the uppermost sheet of the sheets P stacked on the medium cassette 3 is fed toward the downstream of the feed direction, as shown in FIG. 2. The front edge of the sheet P, which is the downstream end, passes through the separator 4 and reaches the first roller pair 8.

The sheet P is fed to the second roller pair 9 disposed further downstream while being pressed by first roller pair 8. Then, ink is expelled from the recording head 17 to the front side of the sheet P when the sheet P is fed downstream while being pressed by the second roller pair 9. The sheet P is fed further downstream while being pressed by the third roller pair 10. Since the fan 25 is operated during this feed, air above the ejection stacker 20 is drawn and fed to the front side of the sheet P. This enables the ink expelled on the front side of the sheet P to be dried fast.

That is, the ink is expelled on the front side of the sheet P and absorbed from the front side of the sheet P. In this process, the fiber on the front side of the sheet P absorbs ink and swells, but the back side remains unchanged. Accordingly, the sheet P tends to curl with the front side facing outward and the back side facing inward.

When the drying of the ink is hastened immediately after the recording, the degree of curling can be reduced as compared with a structure in which air is not fed to the front side of the sheet P.

This is because the amount of ink absorbed by the fiber can be reduced by drying the front side of the sheet P as compared the structure in which air is not fed to the front side of the sheet P.

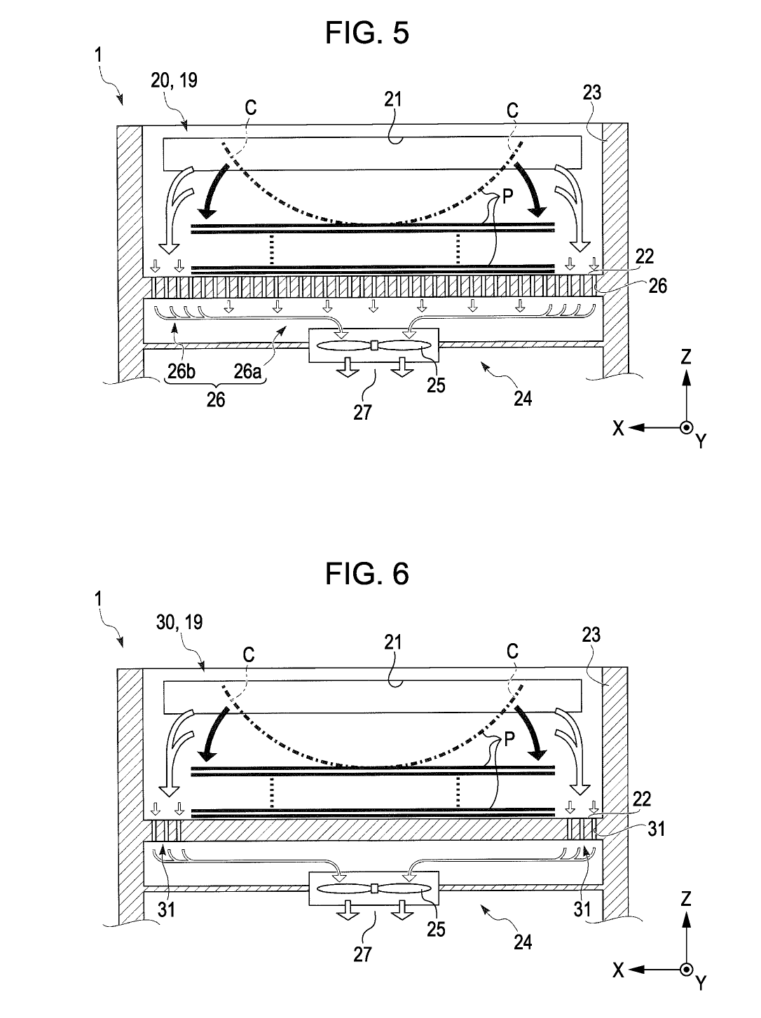

Even after the fiber has absorbed the ink, the drying can be hastened as compared the structure in which air is not fed to the front side of the sheet P. Therefore, even after the fiber has swollen and curls C (see FIG. 5) are formed, the degree of the curls C can be reduced. In particular, the feeding of air to the front side of the sheet P is effective to suppress curls C near both side edges in the width direction of the sheet P.

The curl C tends to draw an arc with the fibrous direction of the sheet P taken as an axis. In other words, the curl C tends to curl in a direction orthogonal to the fibrous direction of the sheet P. In general, the fibrous direction of a commercially available sheet P, which is cut to a predetermined standard size, matches a direction in which the longer edges of the sheet P extend. The degree of the curl C tends to vary depending on the type of the sheet P. This is because the degree of swelling, the ease which the sheet P swells, the stiffness of the sheet P itself, and other parameters differ. In this embodiment, it is assumed that the sheet P has been oriented so that the direction of the longer edges of the sheet P matches the feed direction.

The first feed path R1 in this embodiment is slightly curved between the third roller pair 10 and fourth roller pair 11 when viewed from a side. Accordingly, the sheet P can be slightly warped so that it draws an arc, centered around the width direction X orthogonal to the fibrous direction of the sheet P. This facilitates the reduction in the degree of the curl C caused when the sheet P absorbs the ink.

The first feed path R1 in this embodiment is sharply curved between the fourth roller pair 11 and fifth roller pair 12 when viewed from a side, as compared with the curve between the third roller pair 10 and fourth roller pair 11. If the sheet P, which is sharply curled in the width direction X, is fed to the sharply curved portion on the first feed path R1, the sheet P may be wrinkled. To reduce the risk that the sheet P is wrinkled, it is first fed to the slightly curved portion before being fed to the sharply curved portion.

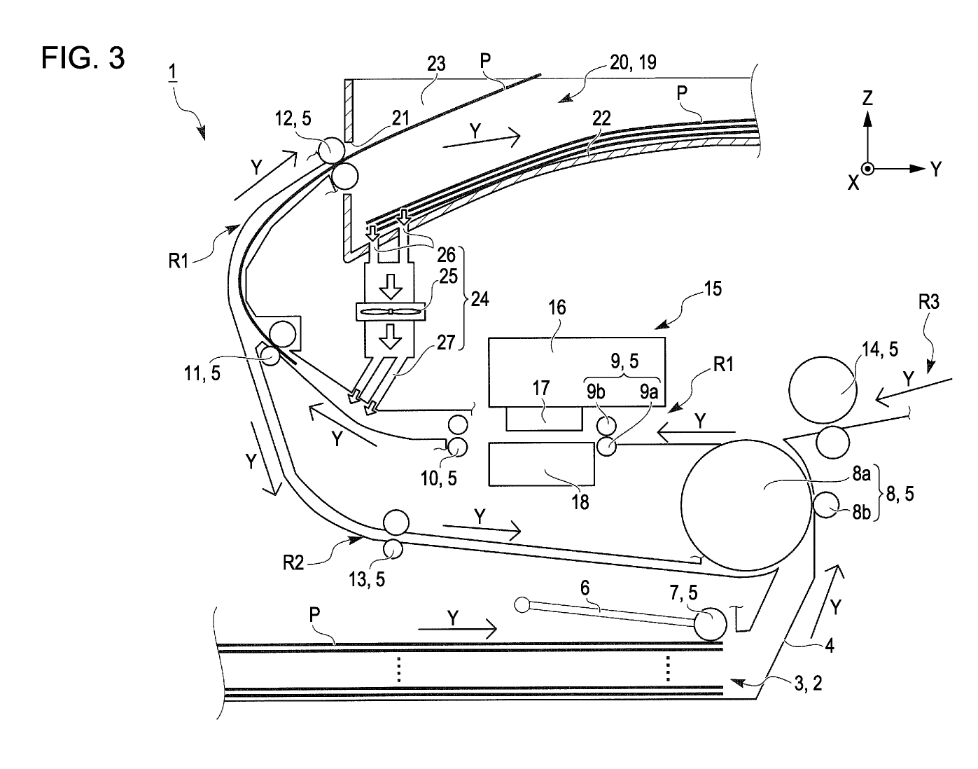

FIG. 3 is a side view that schematically shows the interior of the printer, which is an example of the recording unit according to the embodiment of the invention, when the sheet P is ejected.

When the sheet P is fed further downstream in the feed direction from the state shown in FIG. 2, the sheet P is ejected by the fifth roller pair 12 through the ejection slot 21 onto the ejection stacker 20, as shown in FIG. 3. If, in this embodiment, a single-sided recording mode is in progress, the sheet P is ejected so that the recorded side faces the stacking plane 22. If the double-sided recording mode is in progress, the sheet P is ejected so that the side recorded last faces the stacking plane 22. That is, so-called face-down ejection is carried out.

Of course, the sheet P may be ejected so that the side opposite to the recorded side faces the stacking plane 22. That is, so-called face-up ejection may be carried out.

When the sheet P is ejected, the curls C of the sheet P stacked on the ejection stacker 20 can be reduced or eliminated by the suction force of the suction unit 24.

The plurality of suction holes 26 are formed in the stacking plane 22 at least upstream in the feed direction.

Accordingly, in particular, the curls C of the sheet P can be reduced or eliminated at a place immediately downstream of the ejection slot 21. It is possible to reduce the risk that the rear edge of the leading sheet P already ejected from the ejection slot 21 faces the ejection slot 21. This can reduce the risk that the front edge of the following sheet P, which is to be ejected from the ejection slot 21, strikes the rear edge of the leading sheet P and pushes the leading sheet P forward. Furthermore, the following sheet P can be reliably ejected from the ejection slot 21, eliminating the risk that the following sheet P causes a paper jam near the ejection slot 21.

If the sheet P on the ejection stacker 20 is curled in face-down ejection, when air in a clearance formed by the curl C is drawn, an air flow can be always generated on the recorded side. This enables the ink on the recorded side to be dried fast. That is, the suction force can be used not only to draw air under the curled portion of the sheet P to reduce the curl C but also to hasten the drying of the ink to reduce the curl C.

The stacking plane 22 is slightly curved in the feed direction Y. The curve is effective in facilitating the reduction or elimination of the curls C of the sheet P in the width direction X. The stacking plane 22 is also inclined so that the upstream side is lower than the downstream side in the vertical direction. Therefore, the rear edges of the sheets P stacked on the stacking plane 22 are brought into contact with the lower plane of the ejection slot 21 so that the sheets P are aligned in the feed direction Y.

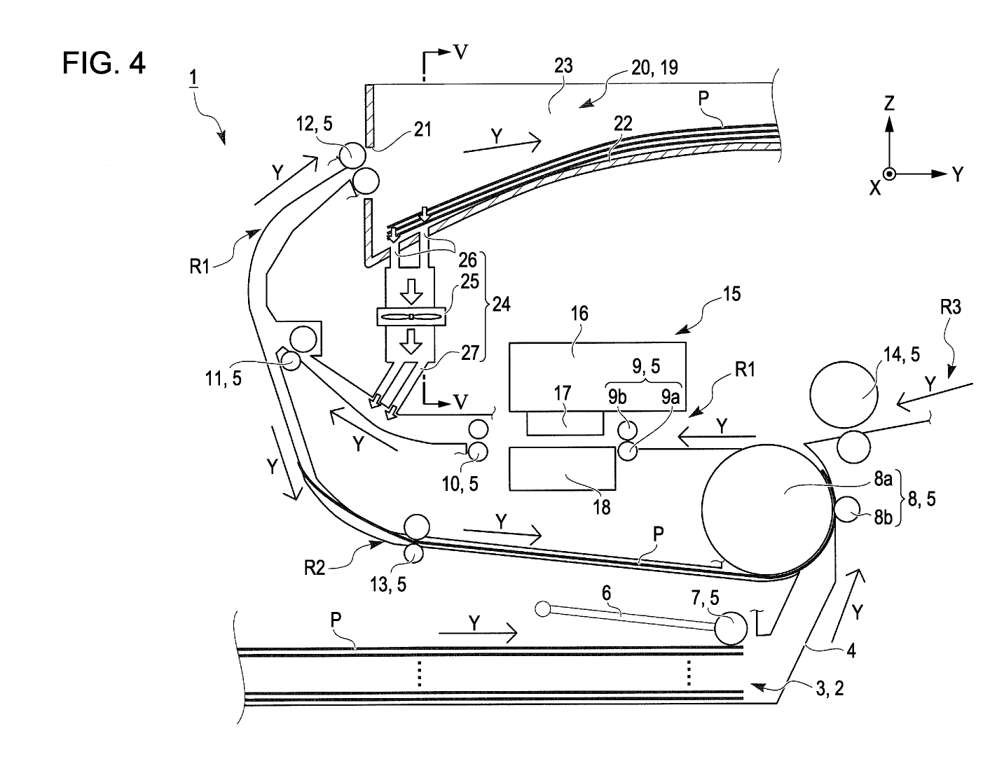

FIG. 4 is a side view that schematically shows the interior of the printer, which is an example of the recording unit according to the embodiment of the invention, when the sheet P is reversed and fed.

While the double-sided recording mode is in progress, upon completion of the recording on the front side of the sheet P, the rear edge of the sheet P passes the fourth roller pair 11. Then, the fifth roller pair 12 is reversely driven when the sheet P, for which recording has been completed on the front side but not on the back side, is pressed and placed in a state in which the sheet P is ready to enter the second feed path R2, as described above.

Therefore, the front edge of the sheet P in the progress direction (the rear edge during printing on the front side) enters the second feed path R2 and reaches the sixth roller pair 13.

The sixth roller pair 13 feeds the sheet P to the first roller pair 8 disposed further downstream, as shown in FIG. 4. The already printed side faces the first drive roller 8a and the non-printed side faces the first driven roller 8b. That is, the sheet P is reversed. The sheet P is fed again to the recording section 15 and recording is carried out on the non-recorded side.

The sheet P is then ejected on the ejection stacker 20 as described above. At that time, the curls C of the sheet P can be reduced or eliminated as in the single-sided recording mode described above.

In the double-sided recording mode, the sheet P is curled in the same direction as in the single-sided recording mode. This is because more ink dries on the side on which printing has been carried out first than on the side on which printing has been carried out last.

FIG. 5 is a schematic cross sectional view of the ejection stacker 20 in the embodiment of the invention, taken along line IV-IV in FIG. 4, when viewed from the front.

As shown in FIG. 5, a plurality of suction holes 26 is formed in the stacking plane 22 of the ejection stacker 20 across the width. When a first sheet P is ejected, air is drawn through suction holes 26a at positions opposite to the first sheet P, so the curls C of the sheet P can be reduced or eliminated.

The circumference of the stacking plane 22 is enclosed by the side walls 23. The side walls 23 are higher than the position of the ejection slot 21. Clearances are left among the side walls 23 and the side edges of stacked sheets P.

When a second and later sheets P are ejected, some suction holes 26a are already blocked by the first sheet P. However, air in the clearance between the leading sheet P and the following sheet P at the top in the stacking direction can be drawn through suction holes 26b formed between each side edge of the stacked sheets P and the relevant side wall 23 of the ejection stacker 20.

Accordingly, even if the following sheet P at the top in the stacking direction is curled near the side edges, a suction force is exerted so as to pull down the portions near the side edges. This can reduce or eliminate the curls C.

That is, the curled sheet P indicated by the dash-dot line can be corrected to the non-curled sheet P indicated by the solid lines.

The printer 1, which is an example of the recording unit according to this embodiment of the invention, includes the feeder 5 that feeds the sheet P, which is an exemplary recording medium, in the feed direction Y, the first feed path R1 through which the sheet P fed by the feeder 5 is guided in the feed direction Y, the recording section 15 that carries out recording on the sheet P fed through the first feed path R1, the second output tray 19, disposed downstream of the recording section 15, on which the sheet P recorded by the recording section 15 is stacked, and the suction unit 24 that draws air above the second output tray 19 through the plurality of suction holes 26 formed in the stacking plane 22, on which the sheet P is stacked, of the second output tray 19. The air drawn by the suction unit 24 is directed to the recorded side of the sheet P recorded by the recording section 15, at a place downstream of the recording section 15 on the first feed path R1 in the feed direction.

In this embodiment, it is preferable that the second output tray 19 is structured so that the sheet P is stacked in such a way that the recorded side of the sheet P recorded by the recording section 15 faces the stacking plane 22 of the second output tray 19.

In the both-side recoding mode, the second output tray 19 only needs to be structured so that the sheet P is stacked in such a way that the side recorded later faces the stacking plane 22.

It this embodiment, it is also preferable that the recording section 15 expels ink to record on the sheet P.

### First Alternative Embodiment

FIG. 6 is a schematic cross sectional view of an ejection stacker in a first alternative embodiment of the invention, when viewed from the front.

As shown in FIG. 6, a plurality of suction holes 31 is formed in a range, on the stacking plane 22 of an ejection stacker 30 in the first alternative embodiment, that does not face the sheet P in the width direction X.

The other members are the same as in the embodiment described above, so their explanation will be omitted by denoting like elements by like reference numerals.

In the first alternative embodiment, as in the case in which the second and later sheets cause curls C in the embodiment described above, air in the clearance caused by the curl C can be drawn by a plurality of suction holes 31 formed between each side edge of the stacked sheets P and the relevant side wall 23 of the ejection stacker 30.

If the first sheet P is curled, a suction force can be exerted so as to downwardly pull portions near the side edges of the sheet P, as in the curls C of the second and later sheets P, and thereby the curl C can be reduced or eliminated.

In the first alternative embodiment, it is preferable that: the stacking plane 22 of the second output tray 19 is enclosed by the side walls 23, which are disposed apart from the edges of the stacked sheets P; and the suction holes 31 are formed between each side edge of the stacked sheets P and relevant side wall 23.

### Second Alternative Embodiment

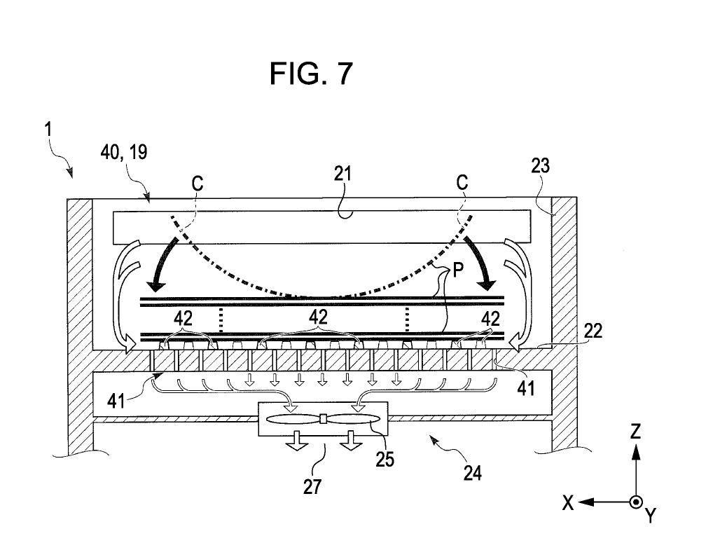

FIG. 7 is a schematic cross sectional view of an ejection stacker in a second alternative embodiment of the invention, when viewed from the front.

As shown in FIG. 7, a plurality of ribs 42 is provided as projections in the width direction X and feed direction Y on the stacking plane 22 of an ejection stacker 40 in the second alternative embodiment. Specifically, the ribs 42 are spaced so as to be divided in the width direction X and feed direction Y. The ribs 42 are formed in a range facing the sheet P at least in the width direction X. The ribs 42 may also be formed outside the above range because the same effect can be obtained as described later.

In the second alternative embodiment, a plurality of suction holes 41 is formed in the range facing the sheet P at least in the width direction X.

Then, when the first sheet P is ejected, air can be drawn through the suction holes 41 at portions facing the first sheet P and the curl C of the sheet P can be reduced or eliminated as in the embodiment described above.

Since the ribs 42 are disposed, there is no risk that the first sheet P blocks the suction holes 41. Accordingly, an air flow can be generated between each side edge of the stacked sheets P and relevant side wall 23.

For the second and subsequent sheets P, therefore, air in the clearance between the leading sheet P and the following sheet P at the top in the stacking direction can be drawn, as in the embodiment described above. Even if the following sheet P at the top in the stacking direction is upwardly curled near the side edges, a suction force is exerted so as to pull down the portions near the side edges. This can reduce or eliminate the curls C.

Unlike the embodiment described above and the first alternative embodiment, after even one sheet P has been ejected, the suction holes 41 can be made invisible to the user. Therefore, the appearance in the second alternative embodiment is better than in the embodiment described above and the first alternative embodiment.

The other members are the same as in the embodiment described above, so their explanation will be omitted by denoting like elements by like reference numerals.

In the second alternative embodiment, it is preferable that: the second output tray 19 further includes the side walls 23 disposed apart from the edges of the stacked sheets P so as to enclose the stacking plane 22, the plurality of ribs 42 disposed at least in the range in which sheets P are stacked on the stacking plane 22 of the second output tray 19; and the suction holes 41 are formed in the range in which sheets P are stacked.

### Third Alternative Embodiment

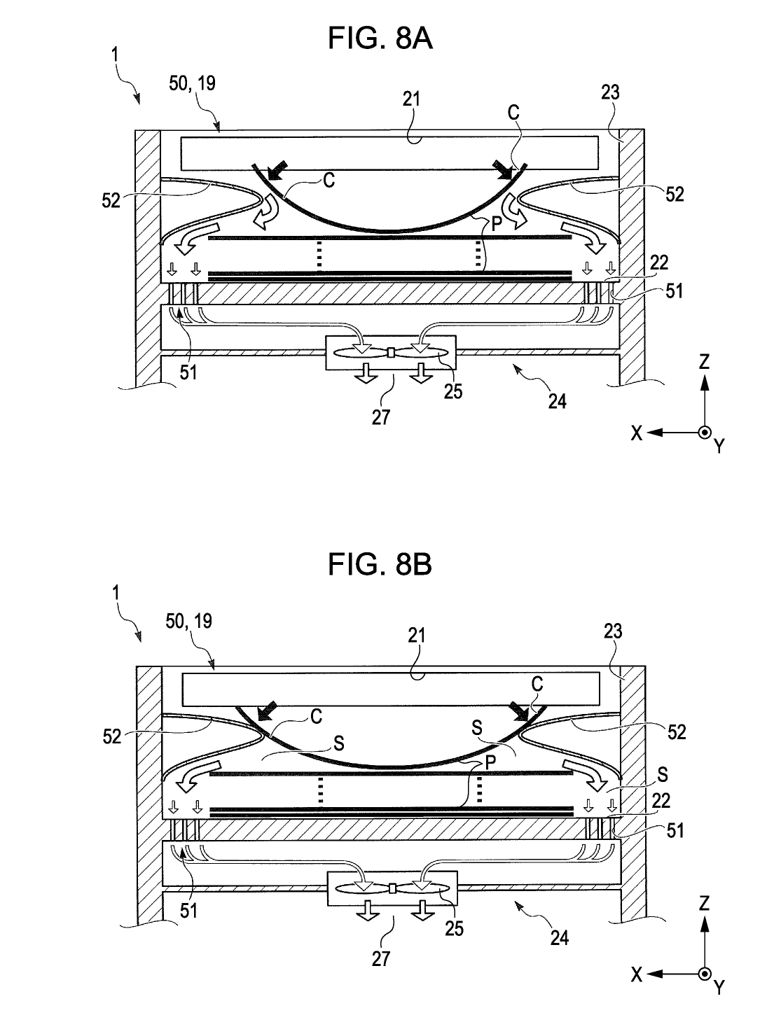

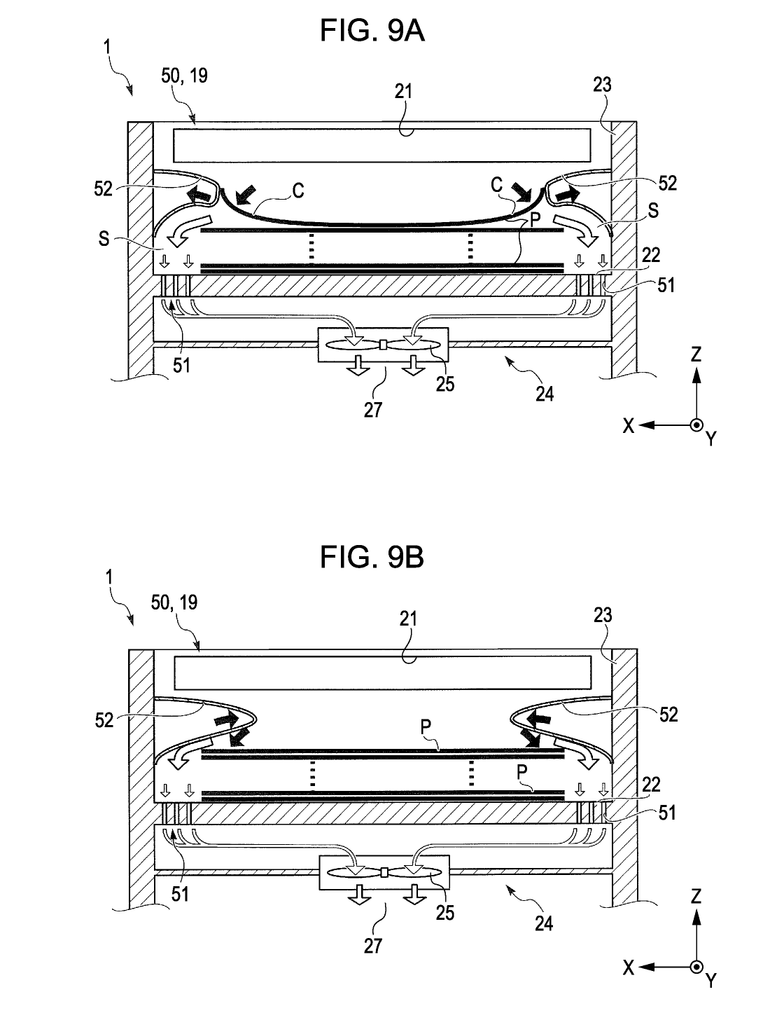

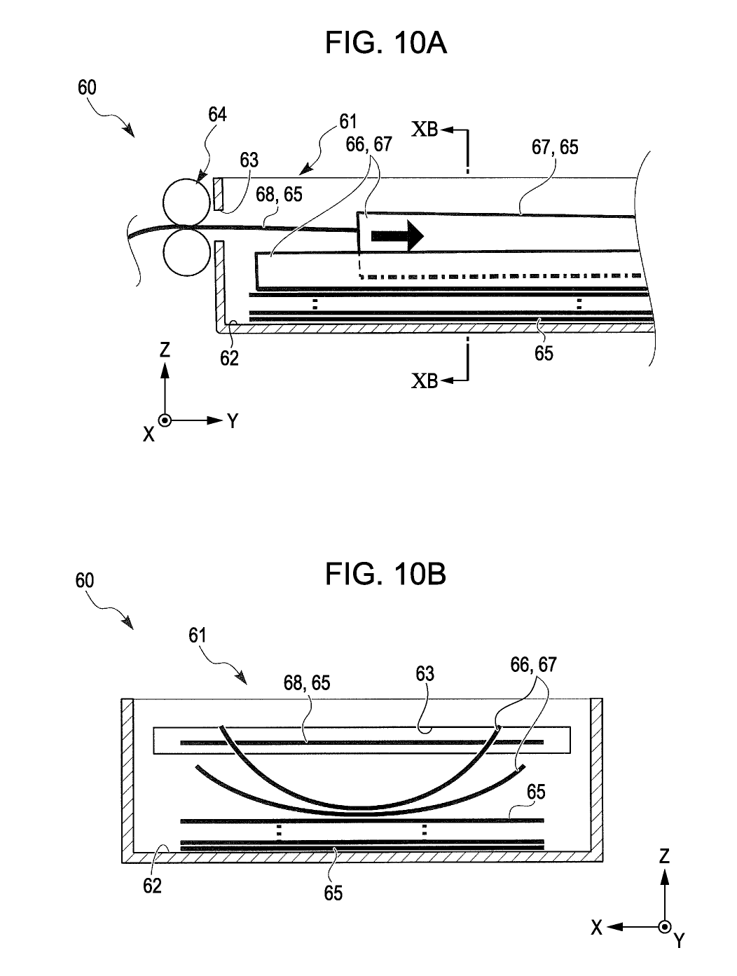

FIGS. 8A and 8B and FIGS. 9A and 9B are cross sectional views of an ejection stacker in a third alternative embodiment of the invention, when viewed from the front.

As shown in FIG. 8A, an ejection stacker 50 in the third alternative embodiment has films 52, formed with an elastic material, on its side walls 23 on both sides, the film 52 being warped so as to form a convex toward the interior. The films 52 are disposed below the ejection slot 21 so that the front edge of the sheet P ejected from the ejection slot 21 is not caught by the films 52. In the feed direction Y, the films 52 are disposed in the range in which the suction holes 51 are formed.

The films 52 are flexible to an extent that they can warped according to the stiffness of the sheet P and the suction force.

In the third alternative embodiment, the suction holes 51 are formed outside a range facing the sheet P at least in the width direction X.

If the ejected sheet P has been upwardly curled at its side edges, therefore, the films 52 can come into contact with the side edges of the sheet P or can be placed close to the side edges of the sheet P. Then, paths through which air flows near the side edges of the sheet P can be narrowed when compared with the embodiment described above and the first and second alternative embodiments.

Accordingly, the suction force exerted near the side edges of the sheet P can be made stronger than in the embodiment described above and the first and second alternative embodiments.

If the sheet P has a small curl C or has no curl C when ejected, the side edges of the sheet P are placed in contact with the films 52, as shown in FIG. 8B.

The other members are the same as in the embodiment described above, so their explanation will be omitted by denoting like elements by like reference numerals.

When the suction force is exerted in the state shown in FIG. 8A, the side edges of the sheet P can be lowered as if they were pulled down as shown in FIG. 8B. Then, the side edges of the sheet P can be placed in contact with the films 52. In this state, a space S enclosed by the sheet P, stacking plane 22, side walls 23, and films 52 is formed, when viewed from the front. Although the space S is not closed in the feed direction Y, the suction force exerted on the side edges of the sheet P can be increased.

When the suction force is further exerted in the state in FIG. 8B, at least either of the films 52 and the vicinities of the side edges of the sheet P are warped as shown in FIG. 9A. Since the suction force is exerted at that time, the enclosed space S is reduced.

When the suction force is further exerted in the state in FIG. 9A, the enclosed space S is reduced, as shown in FIG. 9B. Accordingly, the side edges of the sheet P pass the inner vertexes of the films 52.

That is, the side edges of the sheet P are stacked below the inner vertexes of the films 52 in the vertical direction. This can reliably reduce or eliminate the curls C of the sheet P. The films 52 not only can increase the suction force, but also can press the side edges of the sheet P when the sheet P forms curls C again due to humidity and other factors. That is, after the side edges of the sheet P have been lowered, the films 52 can prevent the side edges from being upwardly displaced.

The above embodiments have been described by using the printer 1 of the ink jet type as an example of the recording unit, but this is not a limitation. The recording unit may be a laser printer. If a laser printer is used, the recorded side of the sheet P tends to contract. Therefore, the sheet P curls in the opposite direction when compared with the printer 1 of the ink jet type. In face-up ejection, therefore, the sheet P tends to form curls C that lift its side edges, so the suction unit 24 of the ejection stacker 50 is particularly useful. Furthermore, when the drawn air is directed to the recorded side of the sheet P, the recorded side is cooled.

Of course, the embodiments described above can be used in any combination.

The films 52 may be formed so that they are simply projected inwardly. In other words, the films 52 may not be warped. The reason why, in the above embodiment, the films 52 have been warped toward the interior is to enable the portions near the curled side edges of the sheet P to easily pass the vertexes of the films 52. If the films 52 are simply projected toward the interior without being warped, when the portions near the curled side edges of the sheet P are pulled down, the films 52 move down together with the side edges of the sheet P. Then, there is a risk that the portions near the side edges of the sheet P remain positioned above the films 52 and do not go underneath the films 52 by cutting around them. There is another risk that no action can be taken for the curls of the following sheet P.

In the third alternative embodiment, it is preferable that: there are further provided the ejection slot 21 used for ejection from the first feed path R1 to the second output tray 19 and the films 52, made of an elastic material, disposed below the ejection slot 21 formed in the ejection stacker 50 of the second output tray 19 in the vertical direction; the films 52 are disposed on the side walls 23 so as to extend toward the interior of the range enclosed by the side walls 23; and part of the surface of each film 52 can come into contact with a side edge of the curled sheet P on the second output tray 19.

It should be understood that the invention is not limited to the above embodiments; various modifications are possible within the scope of the appended claims and these modifications are included in the scope of the invention.

What is claimed is:

1. A recording unit that carries out recording on a recording medium, the recording unit comprising:
a feeder that feeds out a recording medium in a feed direction;
a feed path through which the recording medium fed out by the feeder is guided in the feed direction;
a recording section that carries out recording on the recording medium fed through the feed path;
an output tray, disposed downstream of the recording section in the feed direction, on which the recording medium recorded by the recording section is stacked; and
an air feed guide through which air drawn from a suction hole is supplied to a recorded side of the recording medium in a place, on the feed path, downstream of the recording section in the feed direction; wherein the output tray has the suction hole in a stacking plane on which the recording medium is stacked.

2. The recording unit according to claim 1, wherein:
the stacking plane of the output tray is enclosed by side walls disposed apart from edges of a stacked recording medium; and
the suction hole is formed between one side wall and one edge of the stacked recording medium.

3. The recording unit according to claim 1, wherein:
the output tray further includes side walls, which are disposed apart from edges of a stacked recording medium so as to enclose the stacking plane, and a plurality of ribs within a range in which the recoding medium is stacked on the stacking plan; and
the suction hole is formed within the range in which the recording medium is stacked.

4. The recording unit according to claim 1, further comprising:
an ejection slot, through which recording media are ejected from the feed path onto the output tray; and
a film made of an elastic material, the film being disposed below the ejection slot in the vertical direction; wherein
the stacking plane is enclosed by side walls disposed apart from edges of a stacked recording medium,
the film is disposed so as to face an inside of a range enclosed by the side walls, and
part of a surface of the film is brought into contact with an end of a curled recording medium on the output tray.

5. The recording unit according to claim 1, wherein the output tray is structured so that the recording medium recorded by the recording section is stacked on the stacking plane with the recorded side of the recording medium facing the stacking plane.

6. The recording unit according to claim 1, wherein the recording section expels ink to record on the recording medium and the recording medium is a sheet.
